(19) United States
(12) Patent Application Publication
(10) Pub. No.: US 2010/0007737 A1
(43) Pub. Date: Jan. 14, 2010

(54) METHODS AND SYSTEMS FOR MONITORING A VENUE

(76) Inventors: Chad Ladov, San Francisco, CA (US); Peter C. Sarna, II, Clayton, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/172,986

(22) Filed: Jul. 14, 2008

(51) Int. Cl. H04N 7/18

(52) U.S. Cl. 348/157; 348/E07.085

(57) ABSTRACT

The present invention provides methods and systems for monitoring a venue. The system may comprise a central console operatively connected to, and configured to receive information from, a plurality of elements for monitoring a venue. The plurality of elements may comprise: monitoring equipment providing real-time audio and/or video information regarding the venue; at least one personnel device carried by selected personnel at the venue, wherein the device is configured to communicate information regarding the venue, including information regarding an incident, to the central console; a data processing unit comprising a processor and a database, wherein the database comprises information regarding the venue, including predetermined response plans and information regarding incidents and responses at prior events at the venue, and wherein the processor is configured to analyze the information regarding the venue and provide an output to the central console; and a dispatch unit configured to communicate with third party personnel.

### FIELD OF THE INVENTION

The invention broadly relates to methods and systems for monitoring a venue.

### BACKGROUND OF THE INVENTION

Maintaining order and safety in a large area or venue may be complicated and require great resources. In particular, if large numbers of people are entering and exiting, many issues can arise. Even well managed venues may experience unexpected incidents that may escalate or cause collateral issues if not dealt with appropriately. For example, a person at the venue may take ill, a dispute or similar incident may arise, or a part of the venue may require cleaning, repair or the like. Unfortunately, human actors may have cognitive and perceptual limitations that may impede their ability to analyze and respond to developing incidents appropriately and/or quickly.

### SUMMARY OF THE INVENTION

The present invention involves methods and systems for monitoring a venue. In one embodiment, the system comprises a central console operatively connected to, and configured to receive information from, a plurality of elements for monitoring a venue, wherein the plurality of elements comprises (i) monitoring equipment providing real-time audio and/or video information regarding the venue; (ii) at least one personnel device carried by selected personnel at the venue, wherein the device is configured to communicate information regarding the venue, including information regarding an incident, to the central console; (iii) a data processing unit comprising a processor and a database, wherein the database comprises information regarding the venue, including predetermined response plans and information regarding incidents and responses at prior events at the venue, and wherein the processor is configured to analyze the information regarding the venue and provide an output to the central console; and (iv) a dispatch unit configured to communicate with third party personnel. The central console comprises a display for displaying information received from the plurality of elements and wherein the central console is configured to permit a user to control the plurality of elements from the central console. Information generated by the system is stored in the database

Information generated by the system is stored in the database. The information may comprise security information including the nature and number of any incidents that occur at the venue, the response time to any incidents that occur at the venue and the nature of the response to the incident. The personnel device may comprise a supervisor device operatively connected to a group of staff devices. Each staff device may be carried by a staff member having similar expertise, located a particular physical location within the venue, and/or having similar responsibilities. The staff devices may comprise a dispatch button, a status button, a completion button, a transmitter and a location device. The supervisor device may comprise a PDA and a location device.

In operation, the data processing unit receives information regarding an incident and provides an automated response to the incident. The data processing unit provides instructions to perform a predetermined task. The dispatch unit may be operatively connected to one or more entities selected from the group consisting of: a fire department, a police department, a third party security company, a janitorial staff, and a maintenance staff. The dispatch unit receives information regarding an incident and provides an automated response to the incident, such as a request to third party personnel. The request may comprise information regarding a nature of the incident, a location of the incident, and information regarding the venue.

The display is configured to display information comprising: identities of personnel at the venue, responsibilities of the personnel, capabilities of each of the personnel, real-time location of the personnel, assignments of personnel into groups, information regarding any incident that may arise at the venue, information provided by the monitoring equipment, a map and/or blueprint of the venue, a real-time clock and/or a real-time link to an indicator of a status of an event at the venue, and the nature and number of any incidents that have occurred at the venue during a given period. By way of example, the venue may be a sports venue, an entertainment venue, an education venue, a stadium, an arena, a concert hall, an amphitheater, an amusement park, a water park, a casino, a hotel, a cruise ship, a school or other campus, a racetrack, and a fairground.

Another embodiment of the invention involves a method comprising monitoring a venue using the system set forth above.

A further embodiment of the invention involves a method comprising the steps of: (i) responding to an incident at a venue; (ii) identifying the incident by recognizing that the incident has occurred, is occurring, or is about to occur; (iii) reporting the incident by communicating information regarding the incident to a central console; (iv) receiving information regarding the incident at the central console and a data processing unit; (v) formulating a response to the incident by reviewing the information regarding the incident, accessing a database in the data processing unit, and comparing the information regarding the incident to information regarding the venue; (vi) responding to the incident by executing the formulated response; and (vii) resolving the incident by communicating information regarding the incident to data processing unit for storage in the database.

An additional embodiment of the invention involves a method for optimizing a security response at a venue, comprising the steps of: (i) providing a central console operatively connected to, and configured to receive information from, a plurality of elements for monitoring the venue; (ii) providing a plurality of elements configured to monitor the venue, wherein the plurality of elements comprises: monitoring equipment providing real-time audio and/or video information regarding the venue; at least one personnel device carried by selected personnel at the venue, wherein the device is configured to communicate information regarding the venue, including information regarding an incident, to the central console; and a data processing unit comprising a processor and a database, wherein the database comprises information regarding the venue, including predetermined response plans and information regarding incidents and responses at prior events at the venue, and wherein the processor is configured to analyze the information regarding the venue and provide an output to the central console; a dispatch unit is configured to communicate with third party personnel; (iii) displaying information received from the plurality of elements on the central console; and (iv) monitoring the central console.

### BRIEF DESCRIPTION OF THE FIGURES

FIG. 1 is a block diagram of an embodiment of a system of the present invention.

FIG. 2 is an illustration of an embodiment of a device of the present invention.

FIG. 3 is a block diagram of an element of an embodiment of a system of the present invention.

FIG. 4 is a block diagram of an element of an embodiment of a system of the present invention.

FIG. 5A-5B area exemplary screen shots of a display of an embodiment of a system or method of the present invention.

FIG. 6 is a block diagram of a method of the present invention.

FIG. 7 is a block diagram of a method of the present invention.

FIG. 8 is a block diagram of a method of the present invention.

FIG. 9 is a block diagram of a method of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

It is understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “a device” is a reference to one or more devices and includes equivalents thereof known to those skilled in the art and so forth.

The present invention includes systems and methods. The systems and methods of the present invention may have uses in monitoring a venue. The systems and methods of the present invention may include hardware and/or software elements.

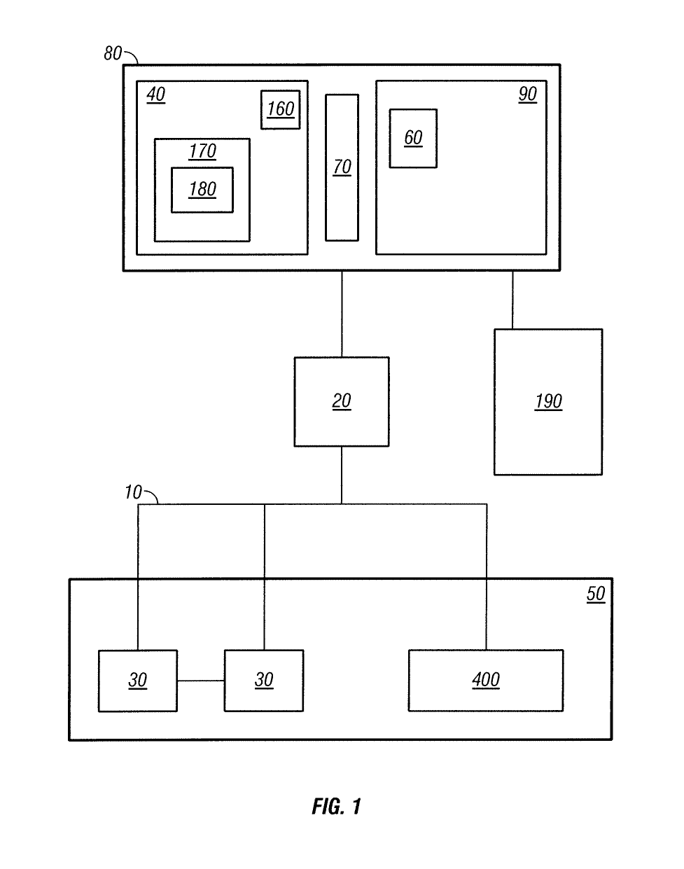

FIG. 1 illustrates an embodiment of the present invention, including a network 10, a supervisor device 20, staff devices 30, monitoring equipment 400, venue 50, Central console 80 and third party personnel 190. In some embodiments each of the above elements is present, but other embodiments may include fewer elements and/or additional elements.

Venue 50 may be any contained or delineated space, for example a sports venue, an entertainment venue, an education venue, a stadium, an arena, a concert hall, an amphitheater, an amusement park, a water park, a casino, a hotel, a cruise ship, a school or other campus, a racetrack, a fairground or any similar environment. In general, the systems and methods have applicability to any environment in which staff, activities and/or security measures may be dispersed or distributed throughout an indoor and/or outdoor space.

Network 10 may be any suitable network that may functionally and/or operatively connect the various elements of the system. For example, network 10 may be an internet or telephonic network. In some embodiments, network 10 may be a wireless network installed in the venue 50, a cellular network, or any suitable network.

Staff device 30 may be any suitable device that permits a staff member to communicate information to one or more other elements in the system. Staff device 30 may have any suitable size, shape, and configuration. In some embodiments, staff device 30 may be a PDA, Blackberry™ device, mobile phone, or radio. In preferred embodiments, staff device 30 is configured to be held and operated in the hand of a person.

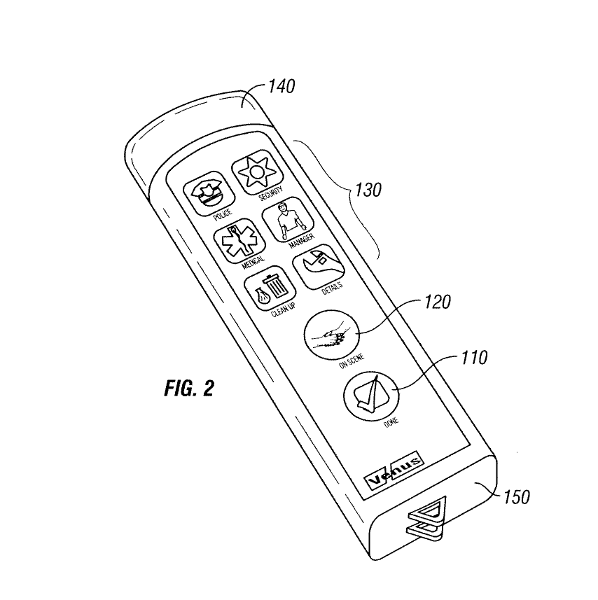

FIG. 2 depicts an embodiment of staff device 30. As illustrated, staff device 30 has a plurality of dispatch buttons 130, status button 120, completion button 110, transmitter 140 and location device 150. The various buttons may have be of any suitable size and configuration, for example a switch, dial, or touch screen. Such buttons when pressed (or otherwise activated) may send a signal and/or information to a supervisor device 20 and/or a central console 80.

Staff device 30 may also include a processor and/or computer readable medium. The processor may be any suitable device capable of receiving and processing information from a computer readable medium. Such computer readable medium may include information regarding the staff device 30 and/or the staff member carrying the device. For example, the computer readable medium may contain an identification number or unit number, the name and/or rank of the assigned staff member, the name of the assigned supervisor (including a number or alpha-numeric code identifying such person or the supervisor unit 20 that person is assigned), the responsibilities of the staff member (including the area of the venue, or the aspect of monitoring or security that staff member may be assigned to), or any other suitable or useful information, including information relating to the functioning of the staff device 30. Such information may be transmitted via transmitter 140.

The dispatch buttons 130 may function to send a signal indicating that additional personnel or resources be dispatched to a site. For example, dispatch buttons 130 may include buttons calling for a police officer, a firefighter, a manager, a security officer, a janitor, a doctor or other medical personnel, maintenance staff, or any other useful personnel or services. In some embodiments, staff device 30 also includes status button 120. When pressed or otherwise activated, status button 120 may be programmed to indicate the position of the holder of the staff device relative to the incident or issue. For example, status button 120 may indicate that the staff member is on his way to the site or that he has already arrived. Other embodiments may include completion button 110. When pressed, completion button 110 may be programmed to indicate the status of the response to the incident/issue and/or the status/resolution of the incident/issue. For example, completion button 110 may be used to communicate that the requested/dispatched personnel have arrived at the scene and/or that the incident/issue has been fully resolved. The information obtained from activating completion button 110 and/or status button 120 may be used, with or without other information, by central console 80 to calculate a total incident duration. Such a total incident duration may be stored in central console 80 for further reference.

Staff device 30 may also include a transmitter 140. Transmitter 140 puts staff device 30 in functional contact with other parts of the system. For example, transmitter 140 may provide staff device 30 with access to a network 10 (FIG. 1), thus placing it in communication with other staff devices 30, a supervisor device 20, and/or a central console 80 (including data processing unit 40 and/or dispatch system 90). Transmitter 140 may also broadcast a radio or cellular signal permitting a staff member to be in voice communication with others. In such an embodiment, staff device 30 also includes a voice receiver and a speaker. In other embodiments, staff device 30 may also include a location device 150. Location device 150 may be any device configured to communicate the staff device's physical location. For example, location device 150 could be a GPS device or a RFID chip.

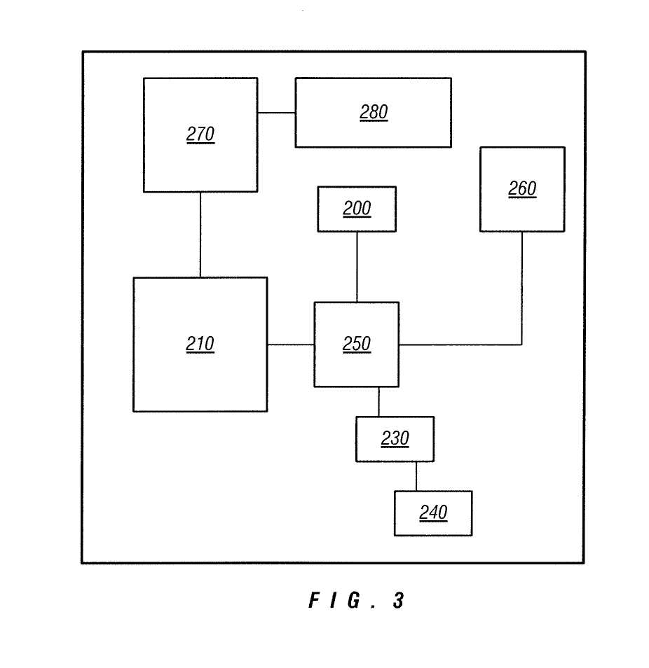

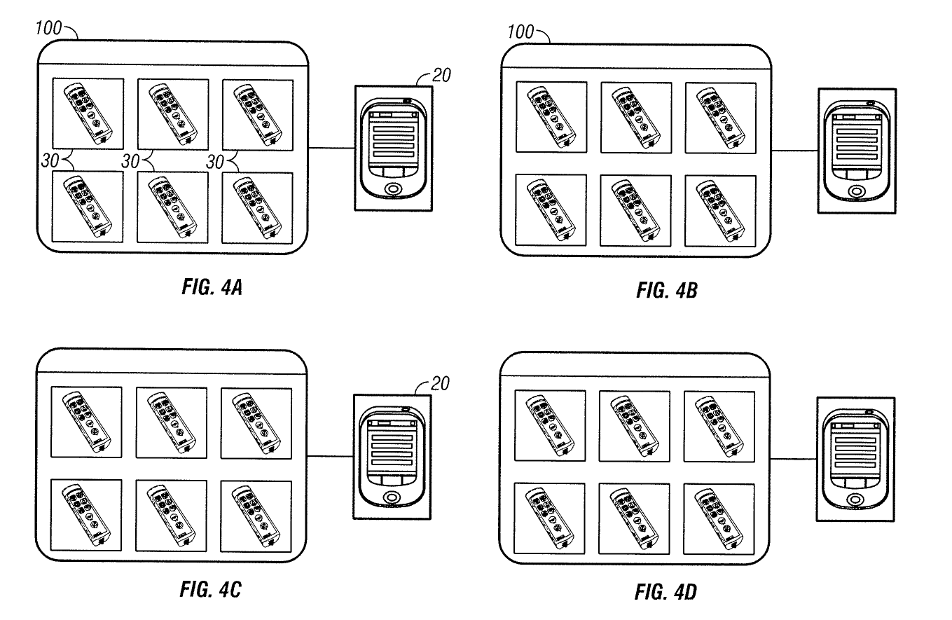

Supervisor device 20 may be any suitable size, shape and configuration. In some embodiments supervisor device 20 may be, for example, a PDA or Blackberry™ type of device. FIG. 3, illustrates an embodiment of supervisor device 20. In the illustrated embodiment, supervisor device may have a transmitter 200 that puts it in one or two-way communication with a network 10 (FIG. 1), a staff device 30, a group 100 of staff devices 30 (FIG. 4), or a central console 80 (including dispatch system 90). In some embodiments, a supervisor device 20 is configured to receive communications from staff device 30 related to the status and/or nature of any reported incident and the staff member's response to such an incident or issue. Supervisor device 20 may also broadcast a radio or cellular signal permitting a supervisor to be in voice communication with others. In such an embodiment, supervisor device 20 would also include a voice receiver/speaker 260. In other embodiments, supervisor device 20 may also include a location device 210. Such a location device 210 may be any device configured to communicate the supervisor device's physical location, for example, a GPS device or a RFID chip.

Supervisor device 20 may also have a processor 250 and/or a computer readable medium 230. Such computer readable medium may include information regarding the supervisor device 20 and/or the supervisor carrying the device. For example, the computer readable medium may contain an identification number or unit number, the name and/or rank of the assigned supervisor, the name of the staff members (or group) assigned to the supervisor (including a number or alpha-numeric code identifying such persons or the staff member unit 20 each may be assigned), the responsibilities of the supervisor (including the area of the venue, or the aspect of monitoring or security that staff member may be assigned to), or any other suitable or useful information, including information relating to the functioning of the supervisor device 20. Such information may be transmitted via the transmitter 200.

Supervisor device 20 may also include a display 270. The display 270 may be of any suitable size, nature, and configuration. For example, the display 270 could be an LCD or similar type of display. The display 270 may show transmitted and/or received information, including security information. For example, the display could show information received from a staff device 30, including any information related to the status and/or nature of any reported incident and the staff member's response to such an incident or issue. In other embodiments, the display also could show instructions or updates received from central console 80.

In some embodiments, supervisor device 20 may also include input 280. Input 280 may be any structure or mechanism by which a person could enter information into supervisor device 20, for example, a keyboard, touch screen, button, or switch. For example, any security information or information regarding a staff member or any other aspect of the venue could be entered via input 280 and placed on the network 10. In other embodiments, supervisor device 20 may include a camera. In some embodiments, images or video clips captured by the camera may be communicated via network 10 to other elements of the system, including central console 80.

FIG. 4 illustrates an exemplary embodiment of a possible organization of staff devices 30 in relation to a supervisor device 20. Staff devices 30 and supervisor devices 30 may each be referred to as a personnel device. In the illustrated embodiment, multiple staff devices 30 are organized into groups 100. Each group 100 is then assigned to a supervisor device 20. The groups 100 may be organized in any suitable manner and may be of any suitable size. For example, groups 100 may be organized by expertise of the staff members, physical location within the venue, rank of the staff members, responsibilities of the staff members. In one example, the groups 100 may include one or more of a security group, medical group, a janitorial group, an ingress/egress control group and a maintenance group. In other embodiments, the groups 100 may be organized by section or level of the venue. In some embodiments there may be more than one level of staff members and supervisors. For example, there may be supervisor units 20 assigned to a group 100, yet there may also be similar groups of supervisor units 20 assigned to more senior personnel.

Monitoring equipment 400 may be any suitable equipment having use in monitoring or providing security to venue 50. For example, monitoring equipment may be a video camera, an audio recording device, face recognition software, ingress-egress monitoring equipment (e.g., ticket readers or scanners). Monitoring equipment 400 may be connected to network 10 such that it may communicate with other elements of the system. In addition, monitoring equipment 400 may be manipulated by one or more of central console 80, supervisor device 20 or staff device 30.

Central console 80 may perform a variety of functions and may include a variety of physical and/or logical elements or modules. Central console 80 may receive and/or collect and/or aggregate various information received from various sources, including multiple systems, units and/or modules. In the embodiment illustrated in FIG. 1, such inputs may include information received from various sources, including staff device 30, supervisor device 20, monitoring equipment 400 or any other sources relating to venue 50. In some embodiments, central console 80 may be in communication with various sources through network 10.

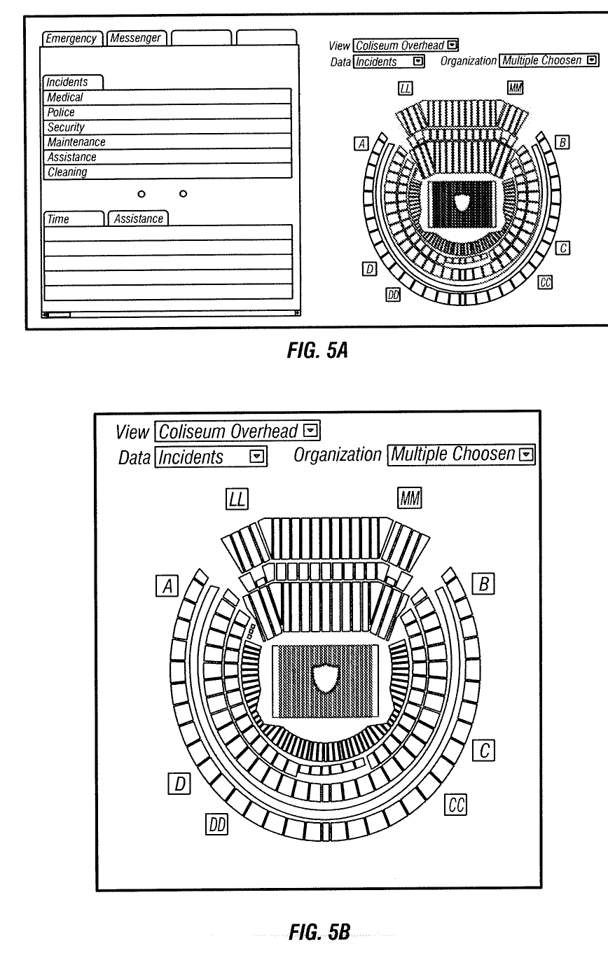

Central console 80 may include a display 70. Exemplary screen shots for a venue 50 are depicted in FIGS. 5A-5B. Display 70 may be anything capable of generating a video display, for example a television or a monitor. The display 70 may include various security information provided by one or more sources. Security information may include any information related to monitoring the status of the venue 50 or person at the venue 50, security of the venue 50, or the status of the security staff (including both staff members and supervisors, and non-security staff such as medical, maintenance and/or janitorial staff). For example, security information may include identities of the security staff, the responsibilities of the security staff, the capabilities of each security staff member, the assignments of staff members to groups or supervisors (e.g., assignments to a particular area of the venue 50 and/or to a particular aspect of security (e.g., ticket taking, security, maintenance), location of personnel (e.g., real-time information received through, for example GPS or RFID tracking, and/or fixed assigned positions (e.g., a particular section of the venue 50), the assignment of supervisors to higher level personnel, information regarding any issue or incident that may arise at the venue 50 (including, for example, the time an incident begins, location of the incident, the security staff assigned to deal with the incident, the time an incident is resolved, the nature of the incident), information regarding the requested response to an incident (for example, whether additional personnel are required and, if so, what capabilities such personnel should have (e.g., police officers, maintenance, firemen)), information provided by monitoring equipment 400 (e.g., audio/video feeds, number of persons that have entered the venue 50). Display 70 may also include one or more of, a map and/or blueprint of venue 50, a real-time clock and/or a real-time link to a scoreboard or some other indicator of the status of the event and/or other happenings at the venue, a table showing the number of incidents (including, e.g., any relevant information such as the status of the incident, the nature of the incident). In some embodiments, display 70 provides real-time information on various aspects of the venue 50.

In some embodiments, central console 80 also permits personnel to respond to incidents and/or communicate with various other personnel. For example, central console 80 may provide command and control of all or a subset of staff at a venue 50. This control may involve providing instructions to various personnel through any suitable method, including email, text message, telephone, or any other suitable communication.

Central console 80 may also include a dispatch system 90. Dispatch system 90 may include various computers or communications apparatus. Dispatch system 90 may be in direct contact, such as through network 10, with data processing unit 40, staff devices 30, supervisor device 20, monitoring equipment 400, or other elements that provide information related to venue 50. Dispatch system 90 may also have a display 60 and such display may be separate from or integral with the central console display 70. Display 60 may be anything capable of generating a video display, for example a television or a monitor. Like display 70, display 60 may include various security information provided by one or more sources. In some embodiments, security information only appears on display 60 when additional personnel are required (or considered) to respond to an incident. In some embodiments, security information only appears on display 60 when dispatch of third party personnel 190 is required or considered. May be in direct contact with third party personnel 190. Third party personnel 190 may be any persons, equipment or the like, that may be useful for monitoring venue 50. For example, third party personnel may include the police or fire department, maintenance personnel, janitorial staff, or private security personnel. In some embodiments when one of the dispatch buttons 130 on staff device 30 is actuated to indicate that police personnel are required, that signal is sent to dispatch system 90 and it appears on display 60. Dispatch system 90, automatically or through personnel operating the dispatch system 90, will contact third party personnel 190. Such contact may include all relevant information regarding the incident that has been communicated to central console 80 by the various elements of the system.

Central console 80 may also include a data processing unit 40. Data processing unit 40 may include a processor 160 and a computer readable medium 170, which may include a database 180. Data processing unit 40 may be any suitable device or set of devices. For example, data processing unit 40 may be a computer, a server, or any other suitable device or devices. Database 180 may be one or more than one database. Database 180 may be organized and configured in any suitable manner and in any suitable format. Database 180 may include information such as security information regarding past incidents at venue 50 or at other venues (in particular venues having one or more features or aspects in common with venue 50), information regarding staff, supervisors and other personnel at venue 50, standard or expected response times for various personnel for various incidents. The processor 160 may be any suitable processor of any suitable configuration and speed, capable of reading, processing and/or interpreting computer executable code and/or other information stored on a computer readable medium. For example, processor 160 could be any one of Intel Corporation's processors (e.g. Xeon®, Centrino®, Celeron®, or Pentium®), Advanced Micro Devices, Inc.'s processors (e.g. Athlon™ or Sempron™), Sun Microsystem Inc.'s processors, or Motorola Inc.'s processors. The computer readable medium 170 may be any suitable medium capable or receiving, storing and or transmitting data or information. may be one or more microprocessors. For example, computer readable medium 170 could be a floppy disk, flash drive, external hard drive, hard drive, ROM chip, cd ROM, or the like.

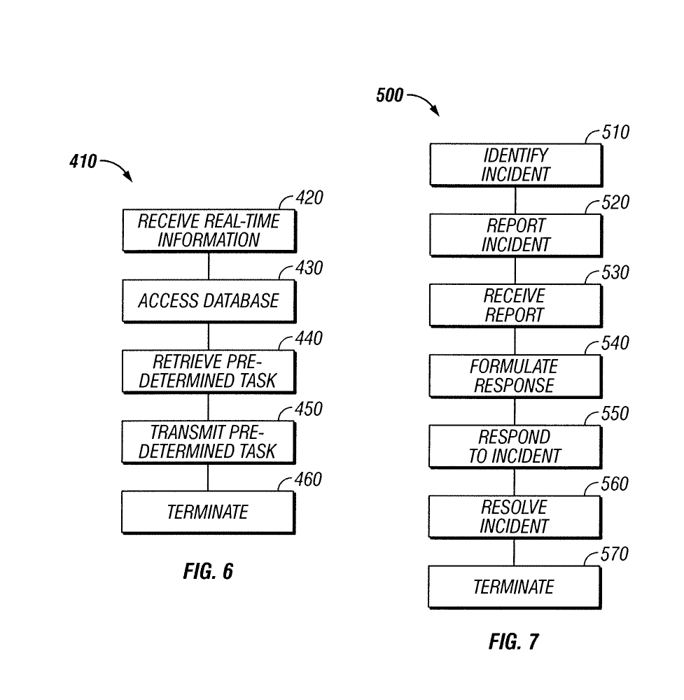

Data processing unit 40 may perform a variety of functions. In some embodiments, data processing unit 40 may store and transmit information regarding a pre-configured task, for example in a database 180 or computer readable medium 170. For example, and with reference to FIG. 6, data processing unit 40 may execute pre-determined task routine 410, which may include receive real-time information step 420, access database step 430, retrieve predetermined task step 440, transmit predetermined task step 450 and termination step 460. Predetermined tasks may include tasks and/or events that are scheduled by real-time or that are schedule to occur at a particular stage of any event that may be occurring at venue 50. Such tasks may be pre-event, event-based, and/or post event.

Receive real-time information step 420 may involve receiving information from a real-time clock or a real-time scoreboard or other source of information about the status of the venue. Access database step 430 involves referencing a database to determine if the there is a pre-configured task scheduled to occur at the received time or milestone. In some embodiments, referencing the database may determine whether there is a predetermined task to take place at a particular time in advance of the real-time information received in received real-time information step 420. In some embodiments the database is stored on computer readable medium 170. Retrieve predetermined task step 440 may involve the identification and/or retrieval of the predetermined task scheduled to occur at the time reported by the real-time clock or scoreboard. In some embodiments, various information regarding the predetermined task may be retrieved, for example, the particular staff required to perform the task, the nature of the task, the supervisor in charge, or any other useful and/or suitable information. Transmit predetermined task step 450 may include transmitting the identified/retrieved predetermined task to display 70, dispatch unit 60, staff device 30, and/or supervisor device 20. In some embodiments, the transmittal may be to only the subset of devices/personnel that are required to take action to execute the pre-determined task. In other embodiments, the predetermined task may also be communicated to each supervisor device 20 and display 70. The transmission may be a message and/or a simple transmission of the task to be performed, including the time frame. The predetermined task may be any suitable task that is schedules to occur at some time while the venue is in use, for example, if the venue is a stadium hosting a football game, a predetermined task may be ceasing the sale of alcohol after the third quarter. Of course, numerous other predetermined tasks may be used.

With reference to FIG. 7, the present invention may also include an incident reporting routine 500. Incident reporting routine 500 may include one or more of identification step 510, reporting step 520, receipt of incident step 530, formulation of response step 540, response step 550, resolution step 560 and termination step 570.

Identification step 510 may include the identification of an incident by a person or equipment. For example, it may include identification of an incident by a staff member, a person at the venue, a supervisor, or by monitoring equipment 400. Identification may include identification that an incident has or is about to occur and/or characterization of the nature of the incident. In other embodiments, it may include an automated identification generated by monitoring equipment 400 or an identification by an operator of monitoring equipment 400. In some embodiments, monitoring equipment 400 may automatically adjust to provide an operator (e.g., one viewing display 70 of central console 80) the best view or vantage point for a particular incident.

Reporting step 520 involves the communication of the incident and/or the nature of the incident and salient facts to others, for example to network 10 for communication to other elements of the system, including supervisor device 20 and central console 80. In some embodiments, reporting step 520 may include subsequent reporting by supervisor device 20. In some embodiments, reporting may include the actuation of one or more of the dispatch buttons 130 on staff device 30. In other embodiments it may involve communication to central console 80 via e-mail, text message, telephone or the like. Reporting step 520 may include various security information, including, for example, the names and responsibilities of any staff members and/or supervisors involved.

Receipt of incident step 530 may include the receipt of the communication made in reporting step 520 by one or more other persons or devices, including the elements depicted in FIG. 1. For example, in some embodiments receipt of incident step 530 includes receipt of the communication by supervisor device 20 and/or central console 80. In some embodiments, it may include reporting the incident via display 70 of central console 80 and/or dispatch system 90. In other embodiments the information is also sent to data processing unit 40.

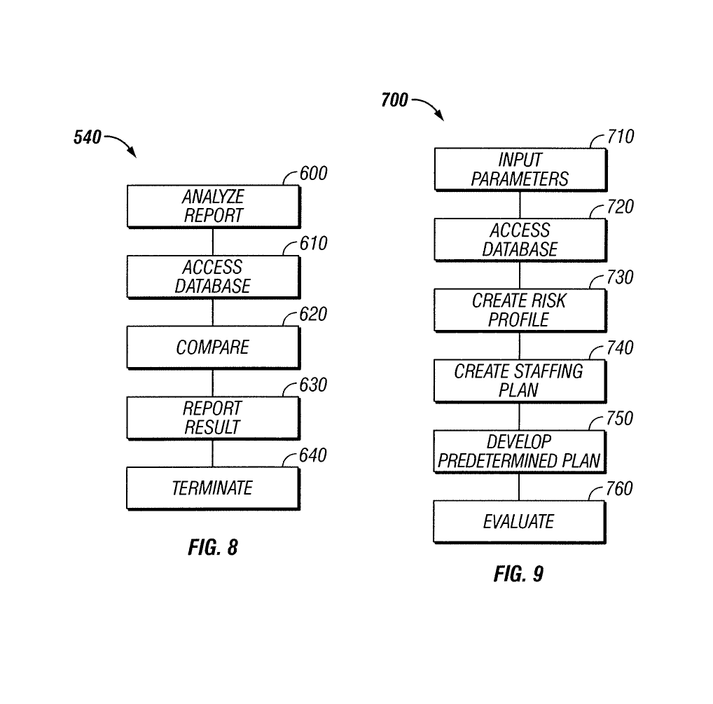

Formulation of response step 540 generally involves identification of the appropriate response or set of potential responses to the reported incident. In some embodiments, formulation of response step 540 may include sub-steps as set forth in FIG. 8, which includes analysis step 600, accessing database (such as database 180) step 610, comparison step 620, reporting step 630, and termination step 640. Analysis step 600 involves a surface level review of the security information received in receipt of information step 530. For example, it may involve the review of items such as reported location of the incident, nature of the incident, available staff, requirements for third party personnel 190. Such a step may be performed, for example, by data processing unit 40, supervisor device 20, personnel operating display 70 and/or dispatch unit 90 of central console 80. Accessing database step 610 involves querying a database (e.g., database 180) having information related to the venue. For example, the database may include information related to past incidents at the particular venue 50 and/or past incidents at other venues (in particular, those having some similarity to venue 50). The database may also contain a set of predetermined response plans for particular incidents or types of incidents. Comparison step 620 compares the information regarding the present incident to information stored in the database, including information regarding past incidents at venue 50 and/or predetermined response plans. In some embodiments, the comparison includes comparing the nature of the incident to the past incidents and/or incidents that have a predetermined response plan. In some embodiments, the comparison includes formulating a suggested response based upon the comparison to the information in the database. Reporting step 630 then communicates all relevant information, including information gathered in analysis step 600 and/or comparison step 620, to other elements of the system. For example, reporting step 630 may communicate the information to central console 80 (including display 70 and display 60 of dispatch unit 90), staff device 30, supervisor device 20, and any other element.

Response step 550 includes directing an appropriate response to the incident. For example, this may involve dispatch unit 90 contacting third party personnel 190, directing appropriate internal personal, such as janitorial, maintenance, medical or security staff to the incident, providing instructions to staff already at the site of the incident. Such response may be sent, for example, by network 10 to various other elements of the system.

Resolution step 560 involves resolving the incident. Resolution step 560 may include execution of instructions sent during response step 560. Resolution step 560 also involves the storage of all relevant information from the incident. Such information may be stored, for example, in computer readable medium 170. The stored information may include the nature of the incident, the location of the incident, the response, the time and staff required to resolve the incident, any direct or collateral effects of the incident, or any other useful or suitable information. In some embodiments, resolution step 560 also involves debriefing of pertinent staff regarding the incident. The debriefing may, for example, occur some time after completion of the event or occurrence at the venue 50. In some embodiments, the debriefing includes showing the information acquired from the particular incident and may include comparing that information to data regarding prior and/or similar incidents.

In some embodiments, the present invention includes a system and method for developing and/or implementing an operational plan for an event or occurrence at a venue 50. With reference to FIG. 9, an embodiment of a method 700 for determining and/or evaluating an operational plan for an event or occurrence is illustrated having input parameter step 710, access database step 720, create risk profile step 730, staffing step 740, predetermined plan step 750 and evaluation step 760.

Input parameter step 710 involves inputting pertinent information regarding, for example, the event or occurrence, venue, budget, available staff (including characteristics of the staff such as experience level). In some embodiments, the parameters are input into a computer, workstation, or the like, that is operatively connected to a system such as data processing unit 40 (FIG. 1).

Access database step 720 may include accessing a database having information pertinent to developing an operation plan for a venue. For example, the database may have information resulting from the methods or systems of the present invention, such as information regarding prior events (including, for example, number of attendees, staffing, incidents and responses, or any other suitable and/or useful information). The database may also include similar information regarding events occurring at venues similar to the venue at issue. The database may be (referring now to FIG. 1) database 180 in central console 80.

Create risk profile step 730, staffing step 740, and develop predetermined plan step 750 all involve analysis of the data in the database accessed in database access step 720. Create risk profile step 730 and staffing step 740 focus on incidents at prior events and/or similar events. In some embodiments, only prior events at the particular venue are analyzed. The step may include mapping and or cataloguing various incidents, including calculating and/or analyzing probabilities of incidents of a certain nature developing at the event being planned. Staffing step 730 also analyzes prior staffing levels, prior staff experience and capabilities, organizational structure (e.g., number of supervisors, number of staff under each supervisor), prior staff assignments, and response times at prior events. Staffing step also factors in the various inputs from step 710, including, for example, the estimated number of attendees and the budget. In some embodiments develop predetermined plan step 750 occurs after steps 730 and 740. In such embodiments, the created risk profile and the level of staffing are analyzed. Prior response times may also be considered.

Evaluation step 760 may include overall evaluation of the various aspects of the operational plan developed in steps 710-750. For example, an overall comparison of the operational plan to prior operational plans may be done. In some embodiments, the aspects are used to simulate response times to various incidents. In some embodiments, evaluation step 760 may include repeating steps 730, 740 and/or 750.

Method 700 may be employed in conjunction with the systems and other methods of the present invention. Indeed, the systems of the present invention may be used to execute method 700, including creation of the database by storing security and other information regarding events that occur at venue 50.

Thus, it is seen that systems and methods for monitoring a venue are provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

While various embodiments of the present invention have been described above, it should be understood that they have been presented by way of example only, and not of limitation. Likewise, the various figures may depict an example configuration for the invention, which is done to aid in understanding the features and functionality that may be included in the invention. The invention is not restricted to the illustrated example configurations, but the desired features may be implemented using a variety of alternative configurations. Indeed, it will be apparent to one of skill in the art how alternative functional, logical or physical configurations may be implemented to implement the desired features of the present invention. Also, a multitude of different constituent part names other than those depicted herein may be applied to the various parts or elements. Additionally, with regard to method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams and other illustrations. As will become apparent to one of ordinary skill in the art after reading this document, the illustrated embodiments and their various alternatives may be implemented without confinement to the illustrated examples. For example, the figures and their accompanying description should not be construed as mandating a particular configuration.

What is claimed is:

1. A system comprising:
a central console operatively connected to, and configured to receive information from, a plurality of elements for monitoring a venue, wherein the plurality of elements comprises:
monitoring equipment providing real-time audio and/or video information regarding the venue;
at least one personnel device carried by selected personnel at the venue, wherein the device is configured to communicate information regarding the venue, including information regarding an incident, to the central console;
a data processing unit comprising a processor and a database, wherein the database comprises information regarding the venue, including predetermined response plans and information regarding incidents and responses at prior events at the venue, and wherein the processor is configured to analyze the information regarding the venue and provide an output to the central console; and
a dispatch unit configured to communicate with third party personnel;
wherein the central console comprises a display for displaying information received from the plurality of elements and wherein the central console is configured to permit a user to control the plurality of elements from the central console.

2. The system of claim 1, wherein the information generated by the system is stored in the database.

3. The system of claim 2, wherein the information stored in the database comprises security information.

4. The system of claim 3, wherein the security information includes a nature and number of any incidents that occur at the venue, a response time to any incidents that occur at the venue and a nature of the response to the incident.

5. The system of claim 1, wherein the personnel device comprises a supervisor device operatively connected to a group of staff devices.

6. The system of claim 5, wherein each staff device is carried by a staff member having similar expertise, located a particular physical location within the venue, and/or having similar responsibilities.

7. The system of claim 5, wherein the staff devices comprise a dispatch button, a status button, a completion button, a transmitter and a location device.

8. The system of claim 5 wherein the supervisor device comprises a PDA and wherein the supervisor device comprises a location device.

9. The system of claim 1, wherein the data processing unit receives information regarding an incident and provides an automated response to the incident.

10. The system of claim 1, wherein the data processing unit provides instructions to perform a predetermined task.

11. The system of claim 1, wherein the dispatch unit is operatively connected to one or more entities selected from the group consisting of: a fire department, a police department, a third party security company, a janitorial staff, and a maintenance staff.

12. The system of claim 1, wherein the dispatch unit receives information regarding an incident and provides an automated response to the incident.

13. The system of claim 12, wherein the automated response comprises a request to third party personnel, wherein the request comprises information regarding a nature of the incident, a location of the incident, and information regarding the venue.

14. The system of claim 1, wherein the central console is connected to the personnel device via a wireless network.

15. The system of claim 1, wherein each of the plurality of elements is operatively connected to each of the other elements.

16. The system of claim 1, wherein the display is configured to display information comprising: identities of personnel at the venue, responsibilities of the personnel, capabilities of each of the personnel, real-time location of the personnel, assignments of personnel into groups, information regarding any incident that may arise at the venue, information provided by the monitoring equipment, a map and/or blueprint of the venue, a real-time clock and/or a real-time link to an indicator of a status of an event at the venue, and a nature and number of any incidents that have occurred at the venue during a given period.

17. The system of claim 1, wherein the venue is selected from the group consisting of: a sports venue, an entertainment venue, an education venue, a stadium, an arena, a concert hall, an amphitheater, an amusement park, a water park, a casino, a hotel, a cruise ship, a school or other campus, a racetrack, and a fairground.

18. A method comprising:
monitoring a venue using the system of claim 1.

19. A method comprising:
responding to an incident at a venue;
identifying the incident by recognizing that the incident has occurred, is occurring, or is about to occur;
reporting the incident by communicating information regarding the incident to a central console;
receiving information regarding the incident at the central console and a data processing unit;
formulating a response to the incident by reviewing the information regarding the incident, accessing a database in the data processing unit, and comparing the information regarding the incident to information regarding the venue;
responding to the incident by executing the formulated response; and
resolving the incident by communicating information regarding the incident to data processing unit for storage in the database.

20. A method for optimizing a security response at a venue, comprising:
providing a central console operatively connected to, and configured to receive information from, a plurality of elements for monitoring the venue;
providing a plurality of elements configured to monitor the venue, wherein the plurality of elements comprises:
monitoring equipment providing real-time audio and/or video information regarding the venue;
at least one personnel device carried by selected personnel at the venue, wherein the device is configured to communicate information regarding the venue, including information regarding an incident, to the central console; and
a data processing unit comprising a processor and a database, wherein the database comprises information regarding the venue, including predetermined response plans and information regarding incidents and responses at prior events at the venue, and wherein the processor is configured to analyze the information regarding the venue and provide an output to the central console;
a dispatch unit is configured to communicate with third party personnel;
displaying information received from the plurality of elements on the central console; and
monitoring the central console.
